(19) United States
(12) Patent Application Publication
(10) Pub. No.: US 2007/0057623 A1
(43) Pub. Date: Mar. 15, 2007

(54) Electroluminescent optical recording medium

(75) Inventors: Rifat Ata Mustafa Hikmet, EINDHOVEN (NL); Marcello Leonardo Mario Balistreri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/559,354

(22) PCT Filed: Jun. 3, 2004
(86) PCT No.: PCT/IB04/50835

§ 371 Date: Dec. 6, 2005

(30) Foreign Application Priority Data
Jun. 10, 2003 (EP) 03101675.1

(51) Int. Cl. H01J 1/62

(52) U.S. Cl. 313/502

(57) ABSTRACT

An optical memory device comprising a stack of layers with a first electrode layer, an electroluminescent layer, a second electrode layer opposite of said first electrode with respect to said electroluminescent layer, and a photo inducible conductor arranged between said electroluminescent layer and one of said first or second electrodes. Further a method of forming a recording structure in such an optical recording medium is proposed. Further, systems for recording and reproducing information stored on such an optical memory device are proposed. In the system for reproducing information an incident light beam induces increased conductivity in said photo inducible conductor layer and light emitted from said electroluminescent layer in response to said incident light beam is directed onto a detector. In the system for recording information an incident light beam suitable for degrading said photo inducible conductor layer material and/or said electroluminescent layer material is generated.

This invention relates to an optical recording medium such as an optical card or an optical disc comprising a stack of layers with a first electrode layer, an electroluminescent layer, and a second electrode layer opposite of said first electrode with respect to said electroluminescent layer. In particular, the invention relates to optical read only memory (ROM) and write once read many (WORM) devices based on electroluminescent materials capable of emitting light when an electric field is applied across a layer made of or comprising such material. The invention further relates to information recording and reproduction systems for recording and reproducing information on/from such an optical recording medium. Finally this invention relates to a method of forming a recording structure within such an optical recording medium.

From WO 00/48197 such optical ROM devices are known including an electroluminescent layer made of plastic, e.g. polycarbonate, polychlorvinyl or polymethylmethacrylate, which serves as mechanical base for the electroluminescent layer. Data is stored in an arrangement of a number of areas (pits) within a plane defined by this electroluminescent layer comprising electrolumiscent material. In particular, every pit contains a layer of electroluminescent material on the bottom of the pit and dissolved in a plastifier. The pixellation and patterning of the emission is achieved through the distribution of the pits. Voltage is applied using a wire netting of transparent electrodes.

Further, in WO 00/48197 optical WORM devices are proposed having a spiral groove in the electroluminescent layer. Every groove contains a thin active layer of a recording medium including an electroluminescent material and a dye composition. Information recording in such a device is done by a focused laser beam which scans the surface of the active layer. The laser radiation is absorbed by the dye that transforms the energy of the laser to heat causing physical and chemical changes in the active layer.

When an electric field is applied across an electroluminescent layer light emission is observed from the total surface area of the layer covered with electrodes. Therefore, in order to reproduce data stored on such a medium the medium has to be structured. In existing optical memory devices this structure is formed by a plurality of regions or patches (pages). A complicated system of electrode structures and electrical connections allows to activate only selected pages and induces emission of light which corresponds to the information stored in the selected page on the memory device. The production cost of such a memory device is very high. Further, the readout of information is fairly complex. The light emitted by the selected page is focused by an objective lens onto a CCD array. More precisely, the light emitted from each pit in one page is focused onto a corresponding CCD pixel. Therefore, the number of CCD pixels has to correspond to the number of pits per page. According to that, the CCD and the electronics for processing the CCD signal is complex which finally increases the cost for such a reproduction apparatus.

Due to a steadily growing demand for storage media with increasing data capacity a need continues for media that have high operating efficiency, dense data capacity and low production cost. Further a system providing easy data recording and reproduction is demanded.

According to a first aspect of the present invention this object is achieved by an optical memory device as described in the opening paragraph which is characterized in that a photo inducible conductor layer is arranged between said electroluminescent layer and one of said first or second electrodes.

Data stored on such a device can be read out by scanning the stack of layers with one or more incident light beam(s) suitable for inducing increased conductivity in the photo inducible conductor layer and thereby locally and successively activating elctroluminesence in the electroluminescent layer corresponding to the stored information. Readout technology as known from CD and DVD can be applied without a need for the complicated system of electrode structures and electrical connections to activate only selected pages. The production costs of such a memory device and a corresponding reproduction apparatus are lower than those of the known electroluminescent memory devices and the CCD reproduction apparatuses.

In principle, the electrodes can be fashioned from any suitable conductor including, but not limited to, a wide variety of conducting materials including indium tin oxide, metals such as gold, aluminum, calcium, copper, indium, iodine, silver and others, alloys thereof, conducting fibers such as carbon fibers, and/or conducting organic polymers such as conducting doped polyaniline and conducting doped polymole. At least one of the electrodes should be fashioned from a transparent material such as indium tin oxide or a partially transparent material such as conducting doped polyaniline so that light generated within the electroluminescent layer can be detected from outside.

The electroluminescent layer may be composed in the manner described above, i.e. the electroluminescent material dissolved in a plastifier is embedded in the form of pits lying in the same plane of the electroluminescent layer carrier material made of a suitable plastic material, preferably polycarbonate, polychlorvinyl, or polymethylmetachrylate. Potential electroluminescent materials for example are electroluminescent organic polymers which may be provided with side groups in order to enhance the photo luminescence in its solid state. Further, molecular light emitters may be used. Laser dyes such as coumarin, Nile red, rhodamine, metal complexes such as tris(8-hydroxyquinolino)aluminum are further examples. In the case of (small) molecules it might be desirable to use multilayer structures where the emitting layer is sandwiched between hole transport and electron transport layers. In this case, the electroluminescent layer in terms of this invention corresponds to said multilayer structure. Inorganic electroluminescent materials which can be used are nano-particles of cadmium selenide, cadmium teleuride, indium phosphide.

Photo inducible conductor layer in terms of this invention is to be understood either as a layer comprising a photo conducting material, wherein, upon absorption of light electrons are excited from its valence band into its conduction band, thereby increasing the conductance. In this case, the photo inducible conductor layer typically is made of a semiconductor material having photo conducting properties. The choice of such material depends on the wavelength of the light used for readout of the stored date. Using electromagnetic radiation in the visible wavelength range cadmium selenide (CdSe) or cadmium sulphide (CdS) would be a preferred choice. Further usable photo conductors are zinc oxide, zinc sulphide. Besides semiconductor material many organic dyes, organic polymers and combinations thereof can also be used. Merocyanine dyes, phthalocyanine dyes are candidates as well as polytiophenes, perylenes, functionalized buckminsterfullerene and mixtures thereof.

Or photo inducible conductor layer in terms of this invention is to be understood as a layer comprising a material whose conductance can be increased by a temperature rise (thermal conductor), whereby the temperature rise occurs upon absorption of light. As thermal conductors, for example, inorganic semiconductors with a low activation energy can be used. Further a multilayer structure may be possible where the incident light is partially absorbed in a separate absorption layer, thereby, indirectly heating a thermal conductor layer attached to the absorption layer. In this case, the photo inducible conductor layer in terms of this invention corresponds to said multilayer structure.

According to a second aspect which constitutes a further development of the first aspect of the invention the stack of layers further comprises a third electrode being arranged between the electroluminescent layer and the photo inducible conductor layer. According to a third aspect which constitutes a further development of anyone of the first or second aspects of the invention the optical memory device comprises a plurality of said stacks of layers laminated onto each other, whereby, the second electrode of one of said stacks corresponds to the first electrode of the next stack.

According to a fourth aspect which constitutes a further development of anyone of the first or second aspects of the invention the optical memory device comprises a plurality of said stacks of layers laminated onto each other, whereby, adjacent stacks are separated by an insulating layer.

According to a fifth aspect which constitutes a further development of anyone of the first to fourth aspects of the invention information is stored in areas within the electrolumiscent layer comprising electrolumiscent material.

According to a sixth aspect which constitutes a further development of anyone of the first to fourth aspects of the invention information is stored in areas within the photo inducible conductor layer comprising photo inducible conductor material.

According to a seventh aspect which constitutes a further development of anyone of the first to sixth aspects of the invention the optical memory device comprises a recording structure formed within the electroluminescent layer by portions of degraded and portions of not degraded electroluinescent layer material.

According to an eighth aspect which constitutes a further development of anyone of the first to sixth aspects of the invention the optical memory device comprises a recording structure formed within the photo inducible conductor layer by portions of degraded and portions of not degraded photo inducible conductor layer material.

Further, according to a ninth aspect of the present invention the above object is achieved by an information reproduction system comprising an optical recording medium according to anyone of the first to eighth aspects of the invention and an information reproduction apparatus comprising a light source arranged to generate an incident light beam suitable for inducing increased conductivity in said photo inducible conductor layer, a beam splitter arranged to direct said incident light beam onto said optical memory device, an optical element arranged to focus the incident light beam onto said stack of layers, means for generating a relative movement between said optical memory device and said focused light beam, and a detector arranged to detect light emitted from said electroluminescent layer in response to said incident light beam, whereby, said beam splitter further being arranged to direct said light emitted from said stack of layers onto said detector.

Further, according to a tenth aspect of the present invention the above object is achieved by an information recording system comprising an optical recording medium according to anyone of the first to eighth aspects of the invention and an information recording apparatus comprising a light source arranged to generate an incident light beam suitable for degrading said photo inducible conductor layer material and/or said electroluminescent layer material.

Further, according to an eleventh aspect of the present invention the above object is achieved by a method of forming a recording structure in an optical recording medium according to anyone of the first to sixth aspects of the invention, the method comprising the steps: applying a mask with transparent regions and opaque regions to said optical recording medium, and exposing said optical recording medium with said applied mask to electromagnetic radiation capable of degrading said electroluminescent layer material or said photo inducible conductor layer material.

The above and other objects, features and advantages of the present invention will become apparent from the following description of preferred embodiments thereof taken into conjunction with the accompanying drawings in which

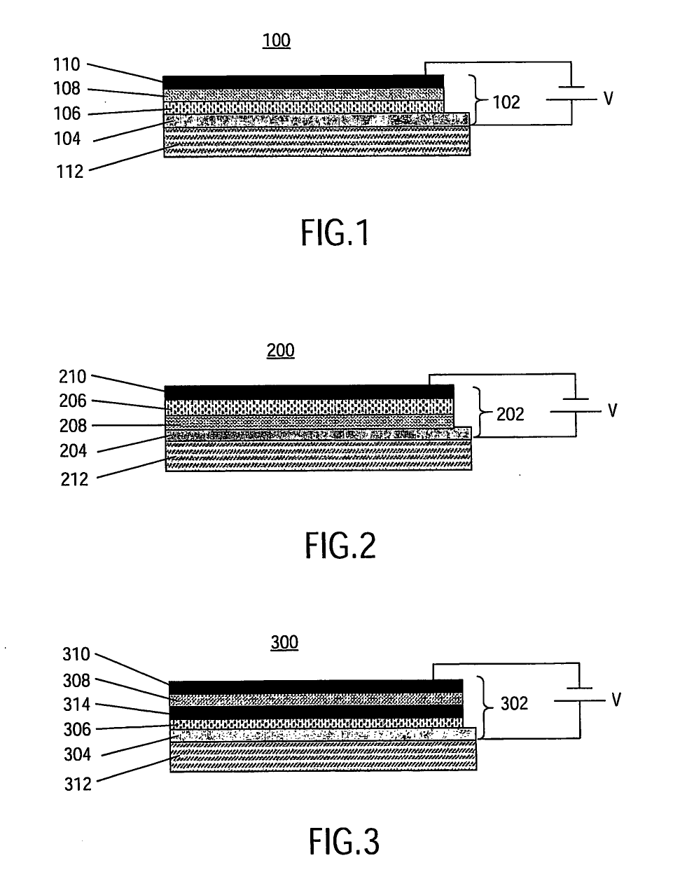

FIG. 1 shows a cross sectional view of an optical memory device according to a first embodiment of the present invention;

FIG. 2 shows a cross sectional view of an optical memory device according to a second embodiment of the present invention;

FIG. 3 shows a cross sectional view of an optical memory device according to a third embodiment of the present invention;

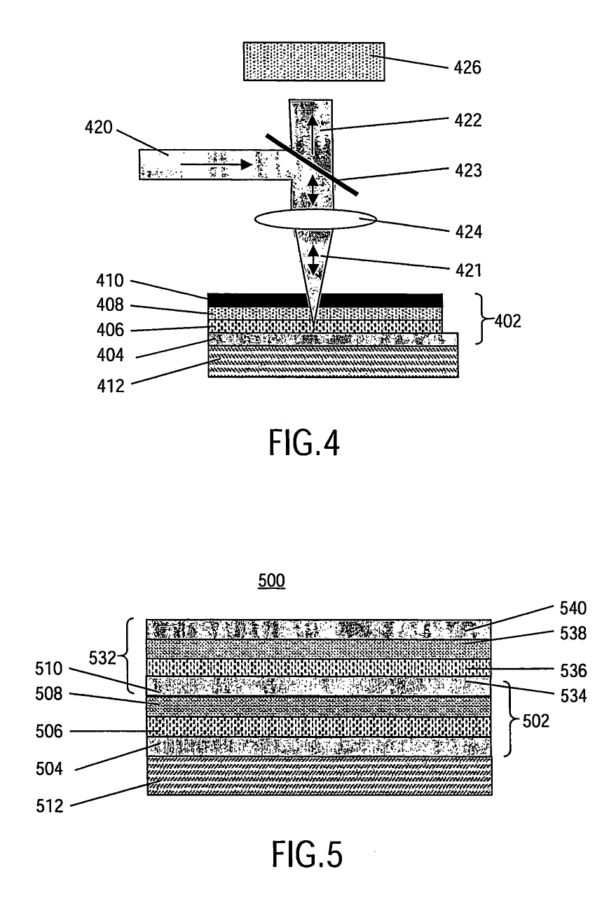

FIG. 4 is a schematic illustration of a read out system according to the present invention;

FIG. 5 shows a cross sectional view of an optical memory device according to a fourth embodiment of the present invention comprising a plurality of stacks; and

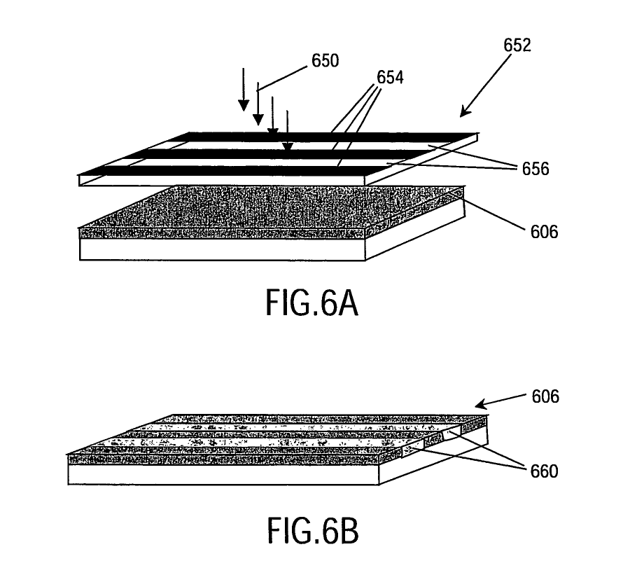

FIG. 6 shows a schematic view of a method for structuring an optical memory device according to the present invention.

The first embodiment of an optical memory device 100 according to FIG. 1 comprises a recording stack 102 with a first electrode 104, an electroluminescent layer 106 laminated onto the first electrode 104, a photo conductor layer 108 laminated onto the electroluminescent layer 106, and a second electrode 110 laminated onto the photo conductor layer 108. This recording stack is attached to a substrate 112 typically made of polycarbonate, PMMA, glass or the like.

The invention is not limited to the arrangement of layers as shown in Fig .1. For example, in the optical memory device 200 according to a second embodiment of the invention as shown in FIG. 2, one can find a permuted order of layers, whereby, the electroluminescent layer 206 is interchanged with the photo inducible conductor layer 208.

The third embodiment of an optical memory device 300 as shown in FIG. 3 comprises an additional (third) electrode 314 arranged in the recording stack 302 between the electroluminescent layer 306 and the photo conductor layer 308. The purpose of the third electrode is to provide the interface between the electroluminescent layer and the photo inducible conductor layer with an electron work function suitable for electroluminesence. This configurations might become necessary when thermal conductors are used as photo inducible conductor layers.

In each of this embodiments, data can be stored either in the electroluminescent layer as known from WO 00/48197, while photo inducible conductor material is homogeneously applied across the photo inducible conductor layer, or it can be stored in the photo inducible conductor layer. In the latter case data may be stored in an arrangement of a number of pits within a plane defined by the photo inducible conductor layer comprising photo inducible material. In particular, every pit may contain a layer of photo inducible conductor material while electroluminescent material is homogeneously applied across the electroluminescent layer. The information may as well be stored in both the electroluminescent layer and the photo inducible conductor layer. In any case, the pixellation and patterning of the emission is achieved through the distribution of the pits.

Further, optical WORM devices can be obtained in the manner described in WO 00/48197: A compound generates free radicals when it is thermally degraded (e.g. azodiizobutyronitryle). A local writing effect is achieved by focusing the writing beam which is absorbed by a dye and consequently converted to heat. These free radicals react with a fluorescent quencher for the electroluminescent material which by this means is bleached. Alternatively, the electroluminescent material may be bleached or degraded by using UV light or by extreme heat. But an optical memory device according to the present invention opens even more options: In principle recording of data may take place either in the photo inducible conductor layer, in the electroluminescent layer or in both. For example the photo conductor layer material as well may be bleached or degraded by using UV light or by extreme heat.

Reproduction of data stored in a recording stack being part of an optical memory device 400 according to the present invention is described below in conjunction with FIG. 4: A laser beam 420 generated by a light source (not shown) is directed by a beam splitter 423 and focused by an optical element such a lens 424 or a lens system onto the recording stack 402. Light in terms of this invention is not limited to the visible spectrum of electromagnetic radiation. Also radiation with shorter or longer wavelength such as ultraviolet or infrared light may be applied. When the focused beam 421 passes the photo inducible conductor layer 408 and, provided information is stored within this layer, strikes a pit with photo inducible conductor material, conductance locally increases and a current flows vertically from one surface of the layer to the other due to a voltage applied across the electrodes 404, 410. The same effect occurs if information is stored in the electroluminescent layer only, and photo inducible conductor material is homogeneously applied across the photo inducible conductor layer. In both cases, the electric field across the electroluminescent layer 406 increases in the area illuminated by the incident focused laser beam 421. As a result the electroluminescent layer 406 emits light—depending on whether or not information is stored—either from a pit with electroluminescent material in this area or from the area illuminated by the incident focused laser beam if electroluminescent material is homogeneously applied across the electroluminescent layer. The emitted light is traced back or collected via the same lens 424, it (partially) passes the beam splitter 423, which part of the emitted light 422 is directed onto a detector 426. The beam splitter 423 may be a semitransparent mirror or a prism. The beam splitter 423 further can be a polarization filter in combination with a quarter wavelength plate in order to reflect the linear polarized incident light beam 420 and to transmit the collected luminescent light 422, or vice versa. Alternatively, in case the wavelengths of the incident light beam 420 and the emitted light 422 are different, a dichroic beam splitter may be provided in order to transmit of the incident light beam and to reflect the collected luminescent light.

Means (not shown) for relative movement between the optical memory device and the focused laser beam 421 shall be provided. These means for example may be a rotary drive for the memory device as known from CD and DVD drives and/or adjustment means for a longitudinal/transversal movement either of a reading head comprising said light source, beam splitter, and lens or of the memory device. Accordingly, since pits and areas not being pits (lands) which do not cause an emission of light alternate due to the relative motion of the memory device and the optical head, in a known manner, a read out signal is generated by the detector 426. Hence, according to the present invention the information is reproduced successively. Therefore, the apparatus, and in particular, the detector 426 can be designed more simple and consequently cheaper than a CCD array for a simultaneous read out of a hole page.

The cross section view of an optical record carrier according to FIG. 5 shows a multilayer structure 500 comprising a plurality of recording stacks 502, 532 being identical with that shown in FIG. 1 attached to a substrate 512. Any other pair of recording stacks according to the present invention may be combined as well. It is to be noted, that according to the embodiment shown in FIG. 5 the second electrode 510 of the first stack 502 corresponds to the first electrode 534 of the second recording stack 532. Alternatively, it is possible to attach two recording stacks according to the present invention with a transparent, insulating spacer layer (not shown in FIG. 5) in between so that the second electrode 510 of the first stack 502 and first electrode 534 of the second stack 532 are formed in separate layers being electrically isolated.

From ROM, WORM, and rewritable CD and DVD it is known that the information on an optical disk is recorded either around in series of concentric circular tracks or on a continuous spiral. Therefore, a grove structure is formed on the medium; in case of (prerecorded) ROM media the sequence of marks representing the information forms such a (discontinuous) structure, in case of recordable WORM or rewritable media a preexisting groove is provided. In any case, the purpose of such a structure is to provide means for controlling the position of the objective lens within the stream of data, and for guiding the reading and/or writing laser beam along the track of data.

Such a structure for tracking purposes may be provided in an optical memory device according to the present invention either in the electroluminescent layer, in the photo inducible conductor layer, or in both. Whereby, the location of the structure does not depend on whether the information is stored within the electroluminescent layer or within the photoconductor layer. Such a structure can be used both for rotating disks as for non-rotating cards. For rotating disks spiral grooves may be provided, for non-rotating cards also parallel grooves can be used. The disk can be readout and written by focusing a laser beam into a small spot with an objective lens while rotating the disk. The non-rotating card can be scanned laterally while the focused laser beam is not scanned, or vice versa.

Such a tracking scheme can be applied to an optical memory device according to the present invention by partially exposing said optical recording medium to electromagnetic radiation, whereby the wavelength of the radiation has to be chosen in order to degrade the electroluminescent layer material or the photo inducible conductor layer material or both. Since most organic molecules can be photo bleached in the presence of oxygen when they are radiated with UV light, preferably UV light may be chosen. In order to obtain the desired track pattern the radiation should be applied to the recording stack or to the separate layer through a mask shadowing the areas which are predetermined tracks for data storage.

In FIGS. 6A and 6B this method is illustrated. A mask or reticle 652 (only a sector of which is illustrated), for example made of glass, contains a pattern to be transferred to the optical memory device. The mask is opaque in the regions (tracks) 654 which are predetermined for data storage, and transparent in the others 656. The mask may be applied to the optical memory device as a whole or, during the production of the optical memory device, directly to a single recording stack or to a desired layer 506, e.g. the electroluminescent layer or the photo inducible conductor layer. Thereby, the mask is brought in close proximity to the layer 606, stack or device. The combination of the mask 652 and layer 606, stack or device is then exposed to ultra violet radiation incident from the side of the mask, as indicated by arrows 650.

The regions 660 of the layer 606, stack or device where light passed the mask, shown in FIG. 6B, were illuminated and subsequently became bleached or degraded. Thereby, either the layers selectively or the stack or medium as a whole lost its electroluminescent and/or photo conducting properties in these regions.

Therefore, data storage on an optical memory device treated in the above described manner will be possible only in regions which are not degraded. A reading or writing beam directed onto such a device will result in a detectable signal only along a sequence of marks in the non degraded track. These marks form a discontinuous structure so that the light emitted from this structure can be detected and used as a tracking signal in the above described manner.

It is noted that the present invention is not restricted to the above preferred embodiments. Other electroluminescent layer materials, electrode layer materials, photo inducible conductor layer materials, and substrate materials may be applied. Further, a cover layer may be attached to the optical memory device on the surface opposite of the substrate.

Furthermore, the invention is not restricted to optical memory devices having a single or dual recording stack configuration. A multiple recording stack configuration comprising more than two recording stacks may be provided. Thereby, recording stacks may be provided with different arrangements of layers.

1. An optical memory device comprising a stack of layers with a first electrode layer; an electroluminescent layer, and a second electrode layer opposite of said first electrode with respect to said electroluminescent layer, characterized in that a photo inducible conductor layer is arranged between said electroluminescent layer and one of said first or second electrodes.

2. An optical memory device according to claim 1, wherein said stack of layers further comprises a third electrode being arranged between the electroluminescent layer and the photo inducible conductor layer.

3. An optical memory device according to claim 1, comprising a plurality of said stacks of layers laminated onto each other, whereby, the second electrode of one of said stacks corresponds to the first electrode of the next stack.

4. An optical memory device according to claim 1, comprising a plurality of said stacks of layers laminated onto each other, whereby, adjacent stacks are separated by an insulating layer.

5. An optical memory device according to claim 1, wherein information is stored in areas within the electrolumiscent layer comprising electrolumiscent material.

6. An optical memory device according to claim 1, wherein information is stored in areas within the photo inducible conductor layer comprising photo inducible conductor material.

7. An optical memory device according to claim 1, comprising a recording structure formed within the electroluminescent layer by portions of degraded and portions of not degraded electroluminescent layer material.

8. An optical memory device according to claim 1, comprising a recording structure formed within the photo inducible conductor layer by portions of degraded and portions of not degraded photo inducible conductor layer material.

9. An information reproduction system comprising an optical memory device according to claim 1 and an information reproduction apparatus comprising a light source arranged to generate an incident light beam suitable for inducing increased conductivity in said photo inducible conductor layer, a beam splitter arranged to direct said incident light beam onto said optical memory device, an optical element arranged to focus the incident light beam onto said stack of layers, means for generating a relative movement between said optical memory device and said focused light beam, and a detector arranged to detect light emitted from said electroluminescent layer in response to said incident light beam, whereby, said beam splitter further being arranged to direct said light emitted from said stack of layers onto said detector.

10. An information recording system comprising an optical memory device according to claim 1 and an information recording apparatus comprising a light source arranged to generate an incident light beam suitable for degrading said photo inducible conductor layer material and/or said electroluminescent layer material.

11. A method of forming a recording structure in an optical recording medium according to claim 1, comprising the steps:
applying a mask with transparent regions and opaque regions to said optical recording medium, and
exposing said optical recording medium with said applied mask to electromagnetic radiation capable of degrading said electroluminescent layer material or said photo inducible conductor layer material.
